(19) United States
(12) Patent Application Publication
(10) Pub. No.: US 2015/0239769 A1
(43) Pub. Date: Aug. 27, 2015

(54) System and Method For Processing End Surface of Optical Fiber

(71) Applicants: TYCO ELECTRONICS (SHANGHAI) CO. LTD., Shanghai (CN); Tyco Electronics UK Ltd, Wiltshire (GB)

(72) Inventors: Yvonne Cai, Shanghai (CN); Zhaoyang Tong, Shanghai (CN)

(73) Assignees: TYCO ELECTRONICS UK LTD, Wiltshire (GB); TYCO ELECTRONICS (SHANGHAI) CO. LTD., Shanghai (CN)

(21) Appl. No.: 14/707,474

(22) Filed: May 8, 2015

Related U.S. Application Data
(63) Continuation of application No. PCT/IB2013/059937, filed on Nov. 6, 2013.

(30) Foreign Application Priority Data
Nov. 9, 2012 (CN) 2012104457638

(51) Int. Cl. C03B 37/15; G02B 6/255

(52) U.S. Cl. CPC C03B 37/15; G02B 6/2551

(57) ABSTRACT

A system for processing an end surface of an optical fiber has an electrode housing unit. The electrode housing unit has a plate-shaped electrode with a first polarity; a set of tip electrodes having a plurality of tip electrodes positioned in parallel with each other and facing the plate-shaped electrode, the plurality of tip electrodes having a second polarity opposite to the first polarity; and an electric discharge arc area positioned between the plurality of tip electrodes and the plate-shaped electrode.

### CROSS-REFERENCE TO RELATED APPLICATIONS

This application is a continuation of PCT International Application No. IB2013/059937 filed Nov. 6, 2013, which claims priority under 35 U.S.C. §119 to Chinese Patent Application No. 201210445763.8 filed on Nov. 9, 2012.

### FIELD OF THE INVENTION

The invention is generally related to a system of processing an end surface of an optical fiber, and, more specifically, to a system for processing an end surface of an optical fiber with an electrode discharge device.

### BACKGROUND

Conventionally, a surface of a metal can be plated with an anticorrosion and antifriction coating using a method of surface discharge process. For example, FIG. 1 shows a conventional surface processing method where a tip electrode 201 is positioned to face a metal work material 202, which serves as a ground terminal. The tip electrode 201 may perform various processes, such as plating, soldering, surface cutting and so on, on the metal work material 202.

As disclosed in Chinese Patent No.1106902C, a conventional surface discharge process device has a voltage applied between an electrode, which is made of a modification material or raw material, and a metal work material. The electrode is sacrificially processed to produce a surface discharge on the metal work material in the form a modification layer on the surface of the metal work piece. A plurality of electrodes may be used, with the electrodes being electrically insulated from each other. The electrodes are connected to respective individual power sources that supply discharge pulses to the respective electrodes.

As shown in FIG. 2, two optical fibers can be spliced together using the principles of convention surface discharge process. For example, a pair of tip electrodes 301 and 302 may be positioned opposite to each other. Two optical fibers are then positioned in an electric discharge arc area between the pair of tip electrodes 301, 302, and are spliced together by an electric discharge arc produced in the electric discharge arc area. However, the conventional electrode configuration in FIG. 2 requires a high current in the electrodes, resulting in a surface discharge process where the electrodes consume large amounts of power.

The conventional approach to reduce the power consumption of the electrodes has been to manually process the end surfaces of the optical fibers by multiple, mechanical grinding processes. By processing the ends of the optical fibers, the amount of deposited material required is reduced, resulting in a subsequent reduction in the power needed by the electrodes. The mechanical grinding processes are performed by a grinding device. However, the grinding device often has a large volume that makes its use difficult in the field where the optical fibers are to be spliced.

### SUMMARY

One of the objects of the invention, among others, is to overcome or alleviate one or more of the disadvantages described above.

A system for processing an end surface of an optical fiber has an electrode housing unit. The electrode housing unit has a plate-shaped electrode with a first polarity; a set of tip electrodes having a plurality of tip electrodes positioned in parallel with each other and facing the plate-shaped electrode, the plurality of tip electrodes having a second polarity opposite to the first polarity; and an electric discharge arc area positioned between the plurality of tip electrodes and the plate-shaped electrode.

### BRIEF DESCRIPTION OF THE DRAWINGS

The invention will now be described by way of example with reference to the accompanying Figures, of which:

FIG. 1 is a side view of a conventional surface processing method using an electrode discharge;

FIG. 2 is a side view of splicing two optical fibers with the conventional surface process method using the electrode discharge;

FIG. 3 is a block diagram of a system for processing an end surface of an optical fiber;

FIG. 4 is a perspective view of the system in FIG. 3;

FIG. 5 is a perspective view of an electrode unit;

FIG. 6 is a perspective view of a fiber transport unit;

FIG. 7 is a perspective view of optical fibers transported into the system for processing the end surfaces;

FIG. 8 is a side view of an optical fiber entering into an electric discharge arc area;

FIG. 9 is a side view of an optical fiber entering into an electric discharge arc area; and

FIG. 10 is a control flow diagram of a method for processing an end surface of an optical fiber by using the system.

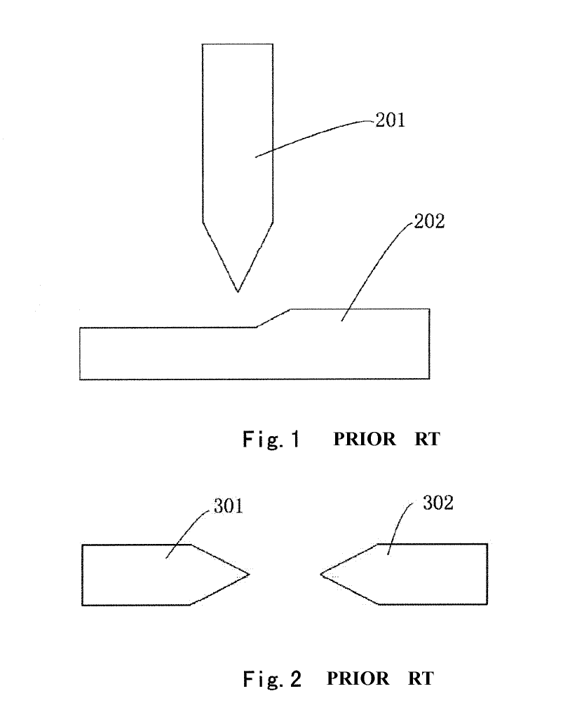

### DETAILED DESCRIPTION OF THE EMBODIMENT(S)

Exemplary embodiments of the invention will be described hereinafter in detail with reference to the attached drawings, wherein the like reference numerals refer to the like elements. The invention may, however, be embodied in many different forms and should not be construed as being limited to the embodiments set forth herein. Rather, these embodiments are provided so that the disclosure will be thorough and complete, and will fully convey the concept of the disclosure to those skilled in the art.

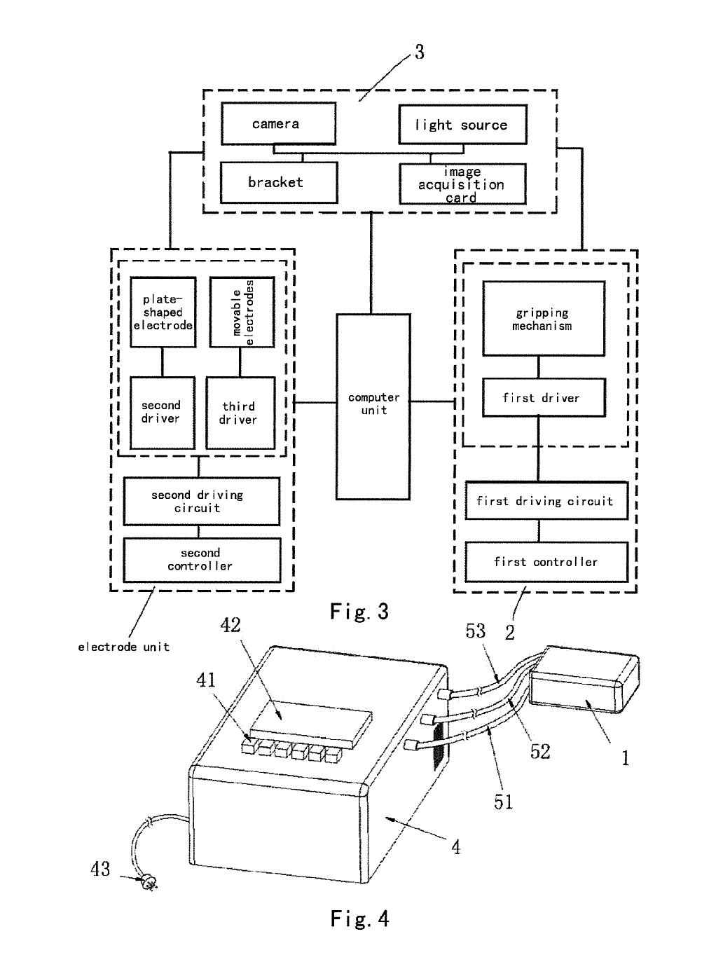

In the embodiments of FIG. 3-7, a system for processing a surface of a nonmetal material is shown, for example, an end surface of an optical fiber. The system has a plurality of electrode housing units 1. Each of the electrode housing units 1 includes a plate-shaped electrode 11 having one polarity, for example a negative polarity; and a set of tip electrodes 12 having an opposite polarity to that of the plate-shaped electrode 11, for example a positive polarity. The tip electrodes 12 are positioned to face the plate-shaped electrode 11.

The set of tip electrodes 12 includes a plurality of tip electrodes 12 positioned in parallel to each other. The plurality of tip electrodes 12 and the plate-shaped electrode 11 are space a distance apart to produce an electric discharge arc area 13 therebetween them. When the tip electrodes 12 and plate-shaped electrode 11 are discharging an end of the optical fiber 50 positioned in the electric discharge arc area 13 is processed. For example, when a voltage is applied between the plate-shaped electrode 11 and the set of tip electrodes 12, an electric discharge arc is produced in the electric discharge arc area 13. When an optical fiber 50 is positioned in the electric discharge arc area 13, the optical fiber 50 is locally heated and melted to eliminate burrs from the end surface and to smooth the end surface, so that the end surface of the optical fiber 50 may be spliced with another optical fiber 50. In this way, the need for conventional mechanical grinding processes on the end surface of the optical fiber prior to splicing is avoided, improving the splicing efficiency. Furthermore, during discharging, a large electric arc spot is produced on the plate-shaped electrode 11, decreasing the current density on the plate-shaped electrode 11, and reducing the power consumption of the electrode.

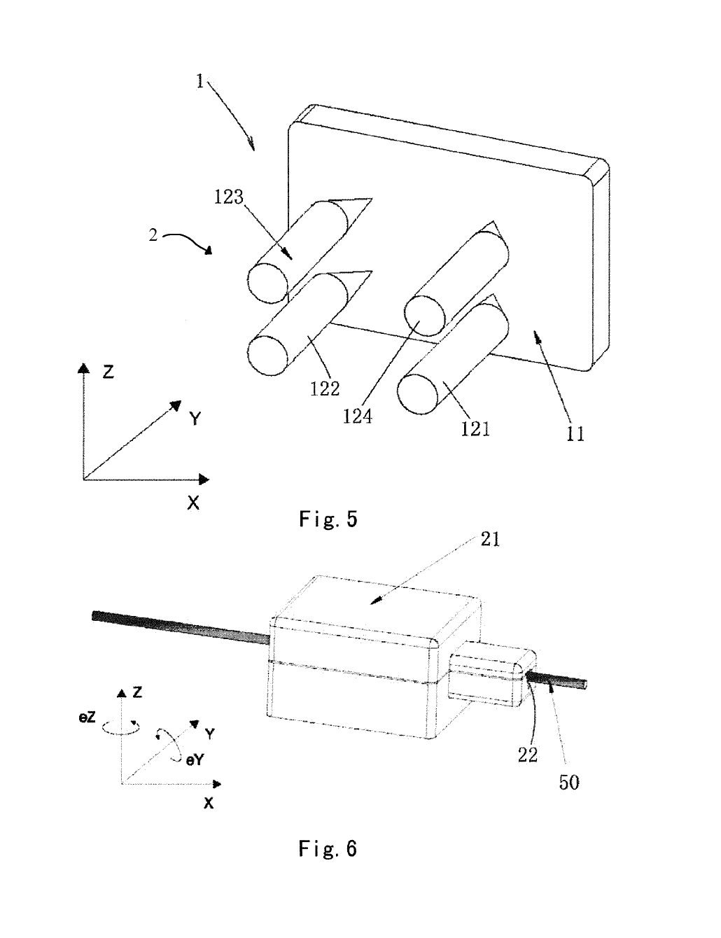

In an embodiment shown in FIG. 5, the tip electrodes 12 in each set include a stationary reference electrode 121 configured to be fixed in a place; and three movable electrodes 122, 123, 124 configured to be movable relative to the stationary reference electrode 121. Each of the tip electrodes 12 may be an asymmetric needle or cone type electrode. Furthermore, the plate-shaped electrode 11 is configured to be movable relative to the stationary reference electrode 121. As a result, by moving at least one of the movable electrodes 122, 123 and 124, a temperature within a local region in the electric discharge arc area 13 can be controlled, so that the end surface of the optical fiber can be processed as necessary to create a desired surface configuration and quality of the optical fiber 50.

In an embodiment, the plate-shaped electrode 11 and the set of tip electrodes 12 of the electrode housing unit 1 constitute a plasma discharge device with a small volume for processing the end surface of the optical fiber 50. Therefore, the user can easily mount the entire system in the field.

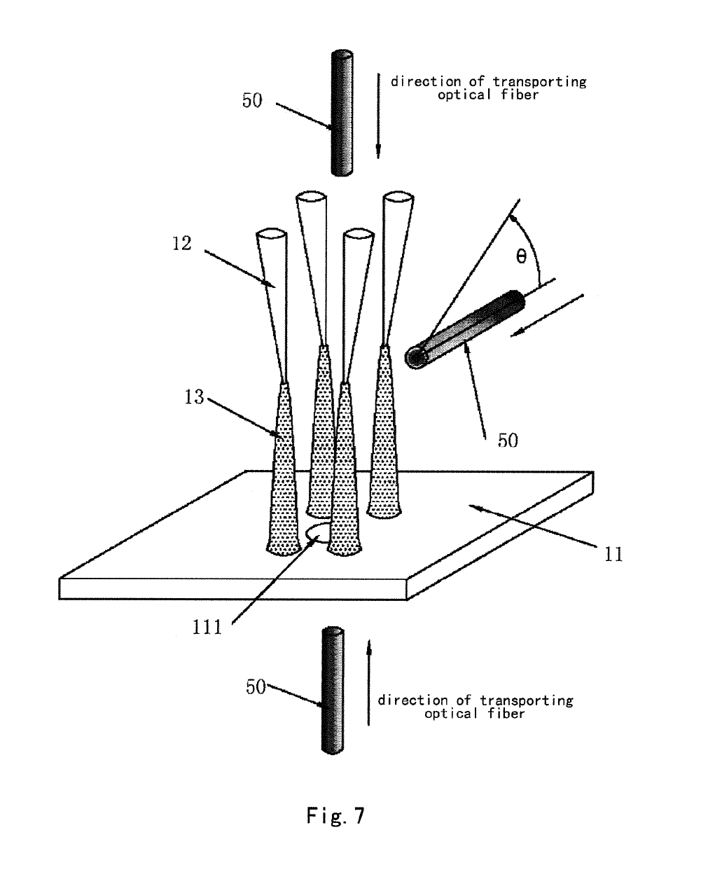

In an embodiment FIG. 7, a through hole 111 is formed in the plate-shaped electrode 11. A nonmetal material, such as the optical fiber 50, may be fed into the electric discharge arc area 13 through the through hole 111. Additionally, a dielectric medium may be fed into the electric discharge arc areas 13 through the through hole 111, or a surface of the plate-shaped electrode 11 may be covered with a dielectric medium to change and guide a pattern of the electric discharge arc, thus customizing a desired process on the nonmetal material.

In an embodiment shown in FIG. 3, the system for processing the end surface of the optical fiber further includes at least one fiber transporting unit 2. Each fiber transporting unit 2 is configured to transport one of the optical fibers 50 into the electric discharge arc area 13 in various directions. In an embodiment, each of the fiber transporting units 2 has a gripping mechanism 21. In the embodiment shown in FIG. 6, the gripping mechanism 21 includes a fiber receiving passageway 22 for holding the optical fiber 50, where the fiber receiving passageway 22 has a substantially V-shaped cross section.

In an embodiment shown in FIG. 3, the system for processing the end surface of the optical fiber includes a plurality of first drivers, each first driver configured to be engaged with the gripping mechanism 21 so as to control a translation, rotation, or inclination of the optical fiber 50 in the electric discharge arc area 13. The gripping mechanism 21 may be a flat plate-like gripper.

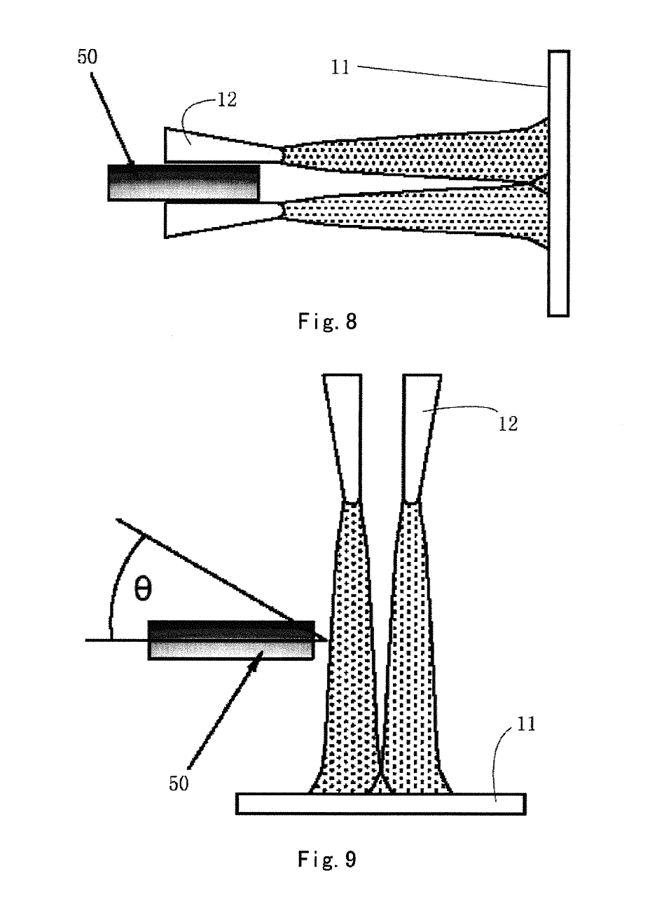

In the embodiments shown in FIGS. 7-9, control of the gripping mechanism 21 permits the optical fiber 50 to be transported into the electric discharge arc area 13 through the through-hole 111 formed in the plate-shaped electrode 11 in: a direction parallel to the tip electrodes 12, may be transported into the electric discharge arc area 13 through the tip electrodes 12 in the direction parallel to the tip electrode 12, or may be transported into the electric discharge arc area 13 between the set of tip electrodes 12 and the plate-shaped electrode in a direction perpendicular to the tip electrode 12.

In an embodiment, the optical fiber 50 may be transported into the electric discharge arc area 13 in an inclination manner in which an axial direction of the optical fiber 50 has an inclination angle θ relative to the plate-shaped electrode 11. Since the optical fiber 50 can be transported into the electric discharge arc area 13 at different locations, in different directions and at different angles, the position and posture of the optical fiber in the electric discharge arc area 13 can be flexibly controlled to uniformly process the end surface of the optical fiber or to create a special configuration of the end surface of the optical fiber.

Therefore, the gripping mechanism 21 of the fiber transporting unit 2 can flexibly transport a part of a work piece to be processed, such as the optical fiber 50, into the electric discharge arc area 13 produced by the electrode housing unit 1 in a translation, rotation or inclination manner. For example, the gripping mechanism 21 may transport the optical fiber 50 into the electric discharge arc area 13 in a direction parallel to, or perpendicular to, an electric discharge arc column or at an inclination angle relative to the electric discharge arc column. In an embodiment shown in FIG. 3, the system further includes a plurality of second drivers, each second driver being configured to drive the respective plate-shaped electrode 11 to move away from or towards the stationary reference electrode 121 in a direction parallel to the tip electrodes 12. In another embodiment, the system further includes a plurality of third drivers, each third driver being configured to drive the respective movable electrode 122, 123 or 124 to move relative to the stationary reference electrode 121. Each of the third drivers has a motor (not shown electrically connected to the respective movable electrode 122, 123 and 124 so as to drive the movable electrode to move in at least one of X-axis, Y-axis and Z-axis directions of a three-dimensional coordinate system. For example, as shown in the embodiment of FIG. 5, the movable electrode 122 may be moved in the X-axis direction, the movable electrode 123 may be moved in the X-axis and Z-axis directions, and the movable electrode 124 may be moved in the Z-axis direction. In this way, a distance between any two electrodes of the plate-shaped electrode 11, the stationary reference electrode 121 and the movable electrodes 122, 123, 124 can be adjusted according to various requirements for processing the optical fiber 50 in the electric discharge arc area 13. Any one of the electrodes 122,123,124 can be reset to its original position by the respective driver. Furthermore, any of the electrodes 122,123,124 can be detached, replaced and maintained.

In an embodiment shown in FIG. 3, the system further includes a plurality of image capturing units 3, each image capturing unit 3 being configured to capture images of positions of the plate-shaped electrode 11, the tip electrodes and the optical fiber 50. The image capturing unit 3 includes a camera for capturing an image, a bracket for supporting and moving the camera, a high light source for illuminating an image-capturing area, and an image acquisition card for storing the image captured by the camera.

In an embodiment shown in FIG. 3, the system further includes a computer unit configured to actuate at least one of the first, second and third drivers based on the captured images to change the position of at least one of the optical fiber 50, the plate-shaped electrode 11 and the tip electrodes, or to adjust a position of the optical fiber 50 by translating, rotating or inclining the optical fiber 50. Further, in an embodiment, the system further includes a first controller and a second controller. The computer unit may be in communication with the first and second controllers, so that the first controller can control the operation of the first driver via a first driving circuit, and the second controller can control the operations of the second and third drivers via a second driving circuit. The computer unit functions as a general monitoring device for monitoring the operation of the entire system in real time and can provide data communication, conversion, process, storage and control for other units and devices. In this way, the computer unit, the fiber transporting unit 2, the electrode housing unit, the first controller, and the image capturing unit 3 constitute a system for automatically processing a surface of a nonmetal material.

The image capturing unit 3 uses the camera to capture a position image of each of the electrodes 122,123,124, and a position image of the work piece to be processed, such as the end surface of the optical fiber. The image storage card stores the captured images, converts the captured images into digitized images and transfers the digitized image data to the computer unit. The computer unit analyses and compares the digitized image data, determines the relative positions of the work piece to be processed and the electrodes 122,123,124, and outputs control signals. The control signals are transmitted to the gripping mechanism 21 of the fiber transporting unit 2 through serial communication to adjust the position of the gripping mechanism 21 relative to the electrodes 122,123,124, thereby adjusting the position of the work piece to be processed.

In an embodiment shown in FIG. 4, the plate-shaped electrode 11, the set of tip electrodes 12, the second driver, and the third driver may be integrated into an electrode housing unit 1. In addition, the second controller and the second driving circuit may be integrated into a control unit 4. The electrode housing unit 1 is electrically connected to the control unit 4 via a positive power cable 51, a negative power cable 52 and a communication control cable 53. In order to reduce the distributed capacitance, the positive power cable 51, the negative power cable 52 and the communication control cable 53 are flexible cables and are spaced apart at intervals or individually from each other to improve the electric property and assembly flexibility of the electrode housing unit 1. In this way, the electrode housing unit 1 is separate from the control unit 4 in space, achieving a flexibility of processing the nonmetal material in the field with the external electrode housing unit 1. However, in another embodiment (not shown), the electrode housing unit 1 and the control unit 4 are formed as an integral piece.

In an embodiment of FIG. 4, the control unit 4 further includes panel control keys 41, a liquid crystal display (LCD) 42 and a power plug 43. The panel control keys 41 and the LCD 42 constitute an interactive interface. By operating the panel control keys 41, control parameters of the electrodes, such as the discharge current intensity, the discharge time and so on, can be input and adjusted to control the discharge arc intensity and the discharge time produced by the electrodes with the control unit 4. Furthermore, displacement parameters of the plate-shaped electrode 11 and the movable electrodes 122, 123, 124 also can be input and adjusted by operating the panel control keys 41, so that the control unit 4 can control the first and second controllers to adjust the positions of the plate-shaped electrode 11 and the movable electrodes 122, 123, 124 in the three-dimensional space. In addition, the input parameters, the positions of the electrodes, the discharge time and the position and posture of the optical fiber 50 in the electric discharge arc area 13 can be displayed on the LCD 42.

The control unit 4 may communicate with the computer unit through serial communication. Alternatively, the control unit 4 may be operated as an individual apparatus to convert and process the data through the panel control keys 41 thereof and a single-chip microcomputer embedded therein.

The fiber transporting unit 2 may be in electronic communication with the computer unit through serial communication. Alternatively, the first controller of the fiber transporting unit 2 may be operated as an individual apparatus to convert and process the data through the panel control keys 41 thereof and a single-chip microcomputer embedded therein. The control panel of the first controller may serve as an interactive interface for monitoring the operation of the gripping mechanism 21. For example, by setting the parameters through the control panel and processing the data through the embedded single-chip microcomputer, the gripping mechanism 21 is rotated or moved in at least one direction of X-axis, Y-axis and Z-axis directions of the three-dimensional coordinate system.

Although the system for processing the end surface of the optical fiber described in the above embodiments includes only a single electrode housing unit 1, the invention is not limited to this. The system may include a plurality of electrode housing units 1 positioned in an array, for example, of 2*1, 2*2, 3*2 or 3*3, so that a plurality of optical fibers 50 (work pieces) can be simultaneously processed. Although an embodiment has been described where the electrode housing unit 1 includes one plate-shaped electrode 11 and four tip electrodes 12, and that the four tip electrodes 12 may simultaneously discharge towards the plate-shaped electrode 11, the invention is not limited to this. In other embodiments, the number of the tip electrodes 12 may be three, five, six or more. In addition, the tip electrodes 12 may discharge at different timings and at different pulse currents under the control of computer unit.

As an automatic control system, with the computer unit, at least one of the fiber transporting unit 2 and the electrode unit is in electronic communication with the computer unit through serial communication connection.

A method of processing an end surface of an optical fiber by using the above described system for processing the end surface of the optical fiber will now be described with reference to

FIGS. 3-10. The method includes the steps of: transporting a plurality of optical fibers 50 into respective electric discharge arc areas 13; and controlling the plate-shaped electrode 11 and the set of tip electrodes 12 to discharge, so that an electric discharge arc is produced to process ends of the optical fibers 50 disposed in the electric discharge arc areas 13. Furthermore, during producing the electric discharge arc, feeding a dielectric medium into the electric discharge arc areas 13 through the through hole in the plate-shaped electrode so as to change and guide a pattern of the electric discharge arc. Alternatively, during producing the electric discharge arc, covering a surface of the plate-shaped electrode with a dielectric medium to change and guide a pattern of the electric discharge arc.

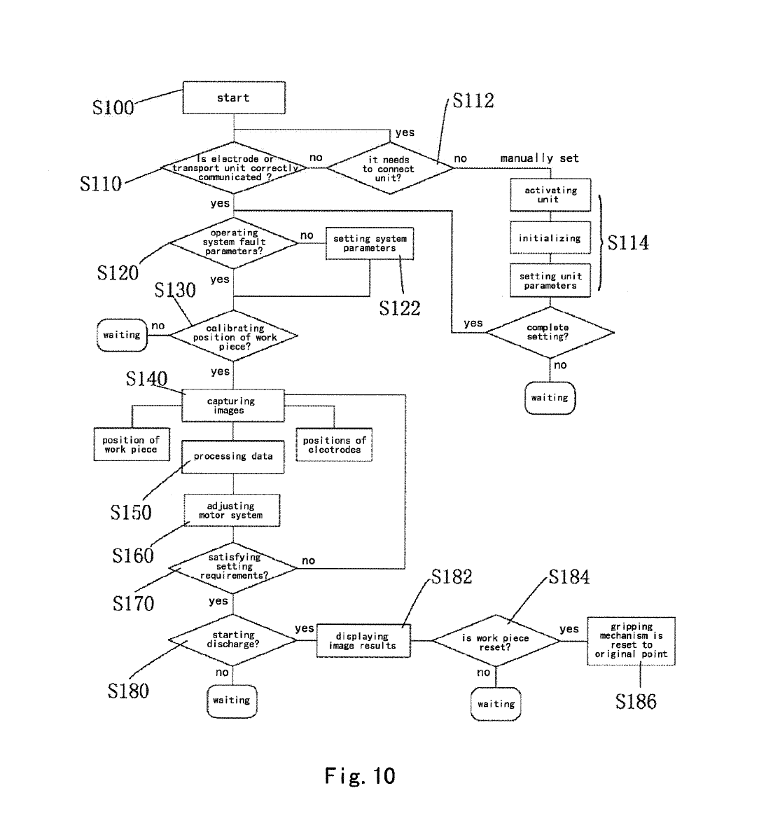

FIG. 10 is a control flow diagram of the method for processing the end surface of the optical fiber by using the system. The system is initialized at step S100. At step S110, the individual electrode unit and the individual fiber transporting unit 2 are determined to be correctly communicating to the computer unit. If the determination result is ‘no’ at the step S110, then the control flow goes to step S112. At the step S112, determining whether the computer unit needs to connect the electrode unit or the fiber transporting unit 2. If determining that one of the electrode unit and the fiber transporting unit 2 is not connected at the step S112, then the control flow goes to S114. At the step S114, manually starting and setting the operation parameters of the unit until completing the setting of the operation parameters of the unit.

If the determination result is ‘yes’ at the step S110, then the control flow goes to step S120. At the step S120, determining whether to operate the default parameters of the system. If the determination result is ‘no’ at the step S120, then the control flow goes to step S122 to set the parameters of the system, otherwise, the control flow goes to step S130. At the step S130, determining whether to calibrate the position of the work piece. After the position of the work piece is calibrated, the control flow goes to step S140. At the step S140, acquiring the positions of the work piece, such as the end surface of the optical fiber 50, and the electrodes by the camera. The position parameters of the electrodes in the electrode housing unit and the position parameters of the work piece in the fiber transporting unit 2 are set through software stored in the computer unit. After the software interface is set correctly, starting to calibrate the position of the work piece.

At step S150, processing, analyzing and determining the acquired images, and the determination result is transferred to the first controller of the fiber transporting unit 2 and the second controller of the electrode housing unit. Thereafter, at step S160, controlling the first, second and third drivers by the first and second controllers to adjust the positions of the electrodes and the optical fiber. And then, at step S170, determining whether the positions of the electrodes and the optical fiber satisfy the setting requirements. If the determination result is ‘yes’ at the step S170, then determining whether to start discharge at step S180. If performing a discharge operation on the work piece to be processed, then displaying the image information of the work piece processed by discharge at step S182. The discharge operation can be repeated by the software or by controlling the panel control keys. Thereafter, at step S184, determining whether to reset the work piece to the original position. If the work piece needs to be reset, then the gripping mechanism is reset to the original point at step S186, for facilitating the removal of the work piece. Upon removal of the work piece, the discharge process on the work piece is finished.

Although the system for processing the end surface of the optical fiber 50 is applied to a cylindrical optical fiber in the above embodiments, the system may equally be applied to a ribbon-shaped optical fiber. That is, the optical fiber 50 may be a cylindrical optical fiber or a ribbon-shaped optical fiber.

The system provides an automatic processing apparatus having a plurality of electrodes for discharging. When the system is applied to process the surface of the nonmetal material, especially the surface of a micro optical device (for example, the end surface of the optical fiber 50), the processed end surface of the optical fiber 50 becomes very uniform and can be repeatedly achieved. Thereby, the processed surface of the optical fiber 50 by the system can be directly spliced with other optical fibers 50 without requiring processing by mechanical processes. Further, the system can flexibly process the end surface of the optical fiber 50, and thus effectively reduce the power consumption of the electrodes. Furthermore, the system has a plasma discharge device with a small volume to process the end surface of the optical fiber 50, allowing a user to easily mount and use the plasma discharge device in the field.

Moreover, in the system and the method for processing the end surface of the optical fiber, the end surface of the optical fiber 50 is automatically processed by an electric discharge arc, so that the glass surfaces of the optical fibers 50 are melt and spliced together, eliminating tiny cracks in the end surface of the optical fiber 50, reducing the surface roughness of the end surface of the optical fiber 50, improving the fatigue strength of the end surface of the optical fiber 50, and increasing the service life of the optical connection.

In the system, the distance between any two electrodes, and the position and posture of the work piece to be processed in the electric discharge arc area can be freely adjusted within a certain range by incorporating the image capturing unit 3 and the computer unit. Those of ordinary skill in the art would appreciate that the above embodiments are intended to be illustrated, and not restrictive. For example, many modifications may be made to the above embodiments by those skilled in the art, and various features described in different embodiments may be freely combined with each other without conflicting in configuration or principle, so that additional variations of the system for processing the end surface of the optical fiber can be achieved.

Although several exemplary embodiments have been shown and described, those of ordinary skill in the art would appreciate that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” or “including” an element or a plurality of elements having a particular property may include additional such elements not having that property.

What is claimed is:

1. A system for processing an end surface of an optical fiber comprising:
an electrode housing unit having a plate-shaped electrode with a first polarity;
a set of tip electrodes having a plurality of tip electrodes positioned in parallel with each other and facing the plate-shaped electrode, the plurality of tip electrodes having a second polarity opposite to the first polarity; and
an electric discharge arc area positioned between the plurality of tip electrodes and the plate-shaped electrode.

2. The system according to claim 1, wherein each set of tip electrodes includes:
a stationary reference electrode; and
at least one movable electrode movable relative to the stationary reference electrode.

3. The system according to claim 2, wherein the plate-shaped electrode is movable relative to the stationary reference electrode.

4. The system according to claim 3, wherein the plate-shaped electrode has a fiber receiving through hole.

5. The system according to claim 1, further comprising a fiber transporting unit that moveably transports the optical fiber into the electric discharge arc area in various directions.

6. The system according to claim 5, wherein the fiber transporting unit includes a fiber gripping mechanism having a fiber receiving passageway.

7. The system according to claim 6, wherein the fiber receiving passageway has a substantially V-shaped cross section.

8. The system according to claim 6, wherein the fiber gripping mechanism is controlled by a first driver.

9. The system according to claim 8, wherein the first driver controls a translation, a rotation, or an inclination of the fiber gripping mechanism.

10. The system according to claim 9, wherein a second driver controls a movement of the respective plate-shape electrode to the stationary reference electrode in a direction parallel to the tip electrodes.

11. The system according to claim 10, wherein a third driver controls a movement of the respective movable electrode relative to the stationary reference electrode.

12. The system according to claim 1, further comprising a plurality of image capturing units positioned to capture images of positions of the plate-shaped electrode, the tip electrodes, and the optical fiber.

13. The system according to claim 12, further comprising a computer unit that actuates at least one of the first driver, second driver, and third driver based on the captured images to change the position of at least one of the optical fiber, the plate-shaped electrode and the tip electrodes and a posture of the optical fiber.

14. The system according to claim 11, the plate-shaped electrode, the set of tip electrodes, the second driver, and the third driver are positioned in the electrode housing unit.

15. The system according to claim 10, wherein each of the tip electrodes is an asymmetric needle type electrode.

16. A method of processing an end surface of an optical fiber comprising the steps of:
providing a system for processing the end surface of the optical fiber having an electrode housing unit with
a plate-shaped electrode with a first polarity,
a set of tip electrodes having a plurality of tip electrodes positioned in parallel with each other and facing the plate-shaped electrode, the plurality of tip electrodes having a second polarity opposite to the first polarity, and
an electric discharge arc area positioned between the plurality of tip electrodes and the plate-shaped electrode;
transporting the optical fiber into the electric discharge arc area; and
controlling the plate-shaped electrode and the set of tip electrodes to discharge, so that an electric discharge arc is produced to process ends of the optical fiber positioned in the electric discharge arc area.

17. The method according to claim 16, further comprising the step of:
during producing the electric discharge arc, feeding a dielectric medium into the electric discharge arc areas through the through hole to change and guide a pattern of the electric discharge arc.

18. The method according to claim 16, further comprising the step of:
during producing the electric discharge arc, covering a surface of the plate-shaped electrode with a dielectric medium to change and guide a pattern of the electric discharge arc.
